(19) United States
(12) Patent Application Publication
(10) Pub. No.: US 2023/0122251 A1
(43) Pub. Date: Apr. 20, 2023

(54) Embedded 2G/NB-IoT Co-deployment with 4G/5G LTE

(71) Applicant: Parallel Wireless, Inc., Nashua, NH (US)

(72) Inventor: Prashanth Rao, Wilmington, MA (US)

(21) Appl. No.: 17/933,480

(22) Filed: Sep. 19, 2022

Related U.S. Application Data
(60) Provisional application No. 63/245,259, filed on Sep. 17, 2021.

(51) Int. Cl. H04W 16/14; H04W 52/54; H04W 72/0453

(52) U.S. Cl. CPC H04W 16/14; H04W 52/545; H04W 72/0453; H04W 84/18

(57) ABSTRACT

In a first embodiment, a method is disclosed, comprising: determining when and where to create a 2G/Narrowband-Internet of Things (NB-IOT) carrier at a 2G base station; starting up the 2G/NB-IOT carrier; creating an interference-free zone for a co-located 4G or 5G carrier co-located with the 2G base station; turning off the 2G/NB-IOT carrier; and reverting the interference-free zone. The method may further comprise embedding one or more 2G/NB-IOT carriers in a guard band of 4G/5G. The method may further comprise transmitting a 2G/NB-IOT carrier from a co-located base station. The method may further comprise using Self-organizing Network (SON) information to determine when a 2G/NB-IOT carrier should be started or shut down. The method may further comprise shutting down a 2G/NB-IOT carrier after use. The method may further comprise creating interference free zones in required regions of the spectrum. The method may further comprise creating interference free zones using a Relative Narrowband Transmit Power (RNTP) Information Element of a X2AP protocol. The method may further comprise creating interference free zones across multiple neighboring eNBs.

### CROSS-REFERENCE TO RELATED APPLICATIONS

This application claims priority under 35 U.S.C. § 119(e) to U.S. Provisional Pat. App. No. 63/245259, filed Sep. 17, 2021 and titled “Embedded 2G/NB-IoT Co-deployment with 4G/5G LTE,” which is also hereby incorporated by reference herein in its entirety for all purposes. The present application also hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850U503). This application also hereby incorporates by reference in their entirety each of U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019; U.S. Pat. App. Pub. No. 2020/0220759A1 “2G/3G Signals Over 4G/5G Virtual RAN Architecture” (PWS-72590US01), filed Jan. 3, 2020; and U.S. patent application Ser. No. 16/773,947, “2G/3G Signals Over 4G/5G Virtual Ran Architecture”, filed Jan. 3, 2020.

### BACKGROUND

Digital cellular networks are networks in which the service area covered by providers is divided into a collection of small geographical areas called cells. Analog signals representing sounds and images are digitized in the phone, converted by an analog to digital converter and transmitted as a stream of bits. All the wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection. In some instances an amount of available bandwidth available for cellular networks can be limited.

### SUMMARY

In a first embodiment, a method is disclosed, comprising: determining when and where to create a 2G/Narrowband-Internet of Things (NB-IOT) carrier at a 2G base station; starting up the 2G/NB-IOT carrier; creating an interference-free zone for a co-located 4G or 5G carrier co-located with the 2G base station; turning off the 2G/NB-IOT carrier; and reverting the interference-free zone.

The method may further comprise embedding one or more 2G/NB-IOT carriers in a guard band of 4G/5G. The method may further comprise transmitting a 2G/NB-IOT carrier from a co-located base station. The method may further comprise using Self-organizing Network (SON) information to determine when a 2G/NB-IOT carrier should be started or shut down. The method may further comprise shutting down a 2G/NB-IOT carrier after use. The method may further comprise creating interference free zones in required regions of the spectrum. The method may further comprise creating interference free zones using a Relative Narrowband Transmit Power (RNTP) Information Element of a X2AP protocol. The method may further comprise creating interference free zones across multiple neighboring eNBs.

SON may also inform an affected neighbor of a punctured eNB/gNB to limit interference in its corresponding frequency space to mitigate intercell interference to the 2G/NB-IoT carrier. The method may further comprise using a coded pattern of bits in an RNTP message to indicate either guard band use or power level of the 2G/NB-IOT carrier. The method may further comprise over-allocating Physical Uplink Control Channel (PUCCH) resources. The method may further comprise scheduling only Physical Uplink Control Channel (PUCCH) resources that may be not the outermost PUCCH frequency resources of a used frequency band. The method may further comprise not scheduling Physical Uplink Shared Channel (PUSCH) in earmarked frequency resources of the 2G/NB-IOT carrier. The method may further comprise donating resources to the 2G/NB-IOT carrier to ensure that its Physical Hybrid ARQ Indicator Channel (PHICH) interference in the donated resources may be minimal to none. The method may further comprise donating resources to the 2G/NB-IOT carrier and not transmitting 4G or 5G reference signals in the donated resources. The method may further comprise choosing, at an eNodeB or gNodeB, Radio Network Temporary Identifiers (RNTIs) to ensure that Physical downlink Control Channel (PDCCH) may be not transmitted in the donated resources.

### BRIEF DESCRIPTION OF THE DRAWINGS

FIG. 1 is a diagram of split options, in accordance with some embodiments.

FIG. 2 is a diagram of split option 7 sub-options, in accordance with some embodiments.

FIG. 3 is a diagram showing two options for the creation of a 2G NB/IOT carrier, in accordance with some embodiments.

FIG. 4 is a flowchart of a method for creating a 2G NB/IOT carrier, in accordance with some embodiments.

FIG. 5 is a schematic network architecture diagram for 3G and other-G prior art networks.

FIG. 6 is an enhanced eNodeB for performing the methods described herein, in accordance with some embodiments.

FIG. 7 is a coordinating server for providing services and performing methods as described herein, in accordance with some embodiments.

### DETAILED DESCRIPTION

A method is described to use unused bandwidth in a network. In one embodiment the method provides a way to co-deploy 2G/NB-IoT with 4G/5G LTE.

The method embeds 2G/NB-IOT carriers (approx. 200 kHz BW per carrier) in guard bands of 4G/5G or in appropriate places within the 4G/5G spectrum. Usually, both systems are transmitted from the location. Self-organizing Network (SON) controls the network, knows when 2G/NB-Internet of Things (IoT) carriers have to be started/shutdown. 2G carrier can be created on demand and shutdown after use inside of functioning 4G coverage i.e., no wastage of spectrum by earmarks.

In some embodiments, SON, which may be via HetNet Gateway (HNG) or another SON gateway, informs co-located 4G/5G carrier to create interference free zones in required regions of the spectrum using Relative Narrowband Transmit Power (RNTP) Information Element of X2 (X2 is beneficial because non-PW eNBs/gNBs can also be controlled).

SON may also inform the neighbors of the punctured (i.e., having a 2G carrier activated in the middle of its transmission band) eNB/gNB to limit interference in their corresponding frequency space to mitigate intercell interference to the 2G/NB-IoT carrier.

SON may use a coded pattern of bits in the RNTP message to indicate additional information such as Guard Band use, power level of 2G/NB-IOT carrier etc.

To ensure proper operation, the eNB/gNB may implement the following schemes, in some embodiments:

If guard band deployment, over-allocate Physical Uplink Control Channel (PUCCH) resources and do not schedule on the outermost PUCCH frequency resources to avoid interference to and from the 2G/NB-IOT carriers.

If middle of the band deployment, Physical Uplink Shared Channel (PUSCH) is not scheduled in the earmarked frequency resources, creating interference free frequency resources for 2G/NB-IoT.

eNB/gNB that donates resources to 2G/NB-IOT chooses its PCI algorithmically to ensure that its Physical Hybrid ARQ Indicator Channel (PHICH) interference in the donated resources is minimal to none.

eNB/gNB does not transmit reference signals in the donated resources. Physical Downlink Shared Channel (PDSCH) is not scheduled in the donated resources.

eNB/gNB chooses UE Radio Network Temporary Identifiers (RNTIs) algorithmically to ensure that Physical downlink Control Channel (PDCCH) is not transmitted in the donated resources.

In some embodiments, information may be used to determine whether there is “demand” for the on-demand 2G NBIOT carriers. For example, IOT (Internet of Things) devices often have a need to transmit data on a periodic schedule, such as at a certain time of day or day of the week. In some embodiments, IOT needs may be anticipated based on historical needs of the particular devices that have connected to the network in the past, and on-demand 2G NB/I0T carriers may be activated for such needs.

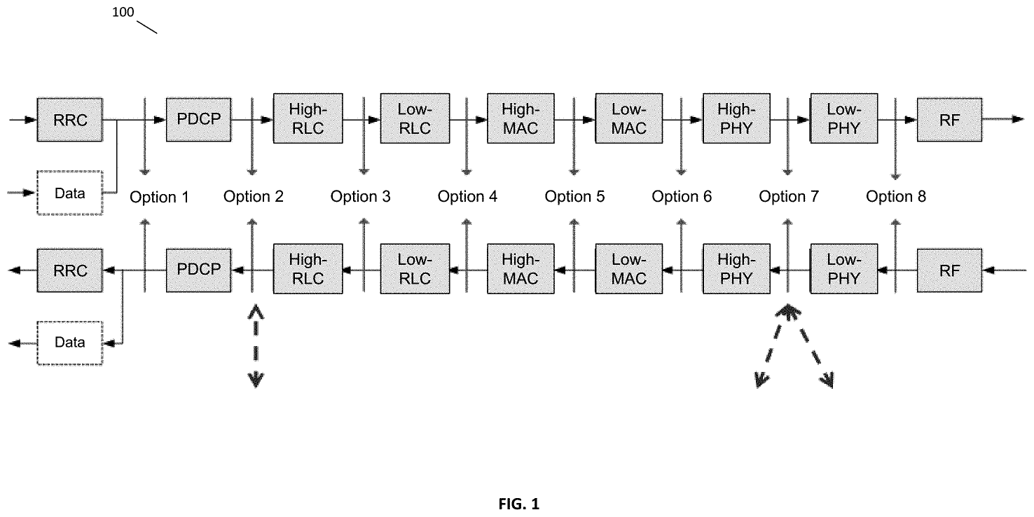

In FIG. 1 split options 1 to 8 100 are presented. Split option 8 defines a split at the ADC output and DAC input. This option is the most demanding one in terms of data rate and latency. Split option 7 defines a split within the PHY layer and will be discussed in the sequel. Split option 6 defines a split between the PHY and the MAC which is considered relatively each to implement and doesn't require high data rates compared to options 7 and 8. Other options presented in the figure above won't be covered in this document since those splits are technology dependent and less of an interest of this work.

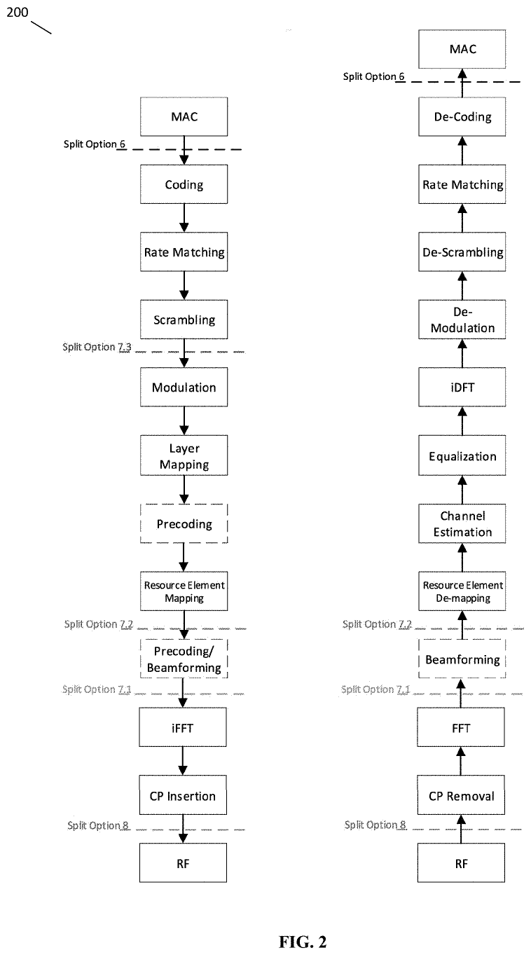

Split option 7 can be then divided into sub-options 200 as shown in FIG. 2.

Split option 7.1 defines a split between the time-domain and frequency domains of the PHY. This option serves well the concept of easily changing the frequency domain implementation at the CU.

Split option 7.2 includes the precoding/beamforming handling on top of Split option 7.1 in the RU. Note that the O-RAN standard defines multiple categories to implement the precoding and beamforming—those are marked in dashed lines in the diagram

Split option 7.3 defines a split at the modulation block. It may or may not include the scrambling block.

We propose the following system and related functionality:

An RU aggregating RF capability and compute platform where: RF capabilities suited for one or more cellular standards, specifically (but not only) 4G, 5G. Compute platform such as ASIC, SoC, general purpose CPU, GPU or equivalent. PHY processing design/SW capable of running complete PHY processing (e.g. option 6) with infrastructure to exercise the full or partial processing abilities in flexible manner. Interfacing capabilities to a DU/CU.

A DU and/or CU capable of running one or more cellular protocol stack SW including: Interfacing capabilities to one or more RUs distributed in space and/or co-located. Scheduling mechanism with suitable algorithms to decide when to apply single or joint processing of the data. Knowledge of neighbor and co-located RU acquired statically (pre-configured) or adapted dynamically. PHY-manager: Management logic for per user/resource (e.g. RB/BWP) to exercise split option 6 or 7.x based on the needed processing capabilities. Single or multi stream PHY processing capabilities with joint processing capabilities.

Interface protocol between the RU to DU/CU including: Capabilities to transport data path traffic and control information per time unit (e.g. TTI in 4G/5G). O-RAN based protocol or equivalent (e.g. serial, or non-standard) regardless of the physical design of the protocol (e.g. CPRI/eCPRI/PCIe/etc.).

During scheduling process, the scheduler will mark which part of the DL and/or UL shall be processed with joint processing (e.g. UL CoMP) and which part shall be processed by single PHY. Based on the scheduler definition, the protocol stack shall provide the data path packets (in DL) and the control data to the PHY manager. In turn, the PHY manager will distribute the single PHY processing data and control data to the relevant RU, where each such RU will exercise split option 6 functionality. The rest of the data path packets required for joint processing will exercise split option 7.x on the RU and the rest of the processing of the upper PHY will be done in the DU or CU.

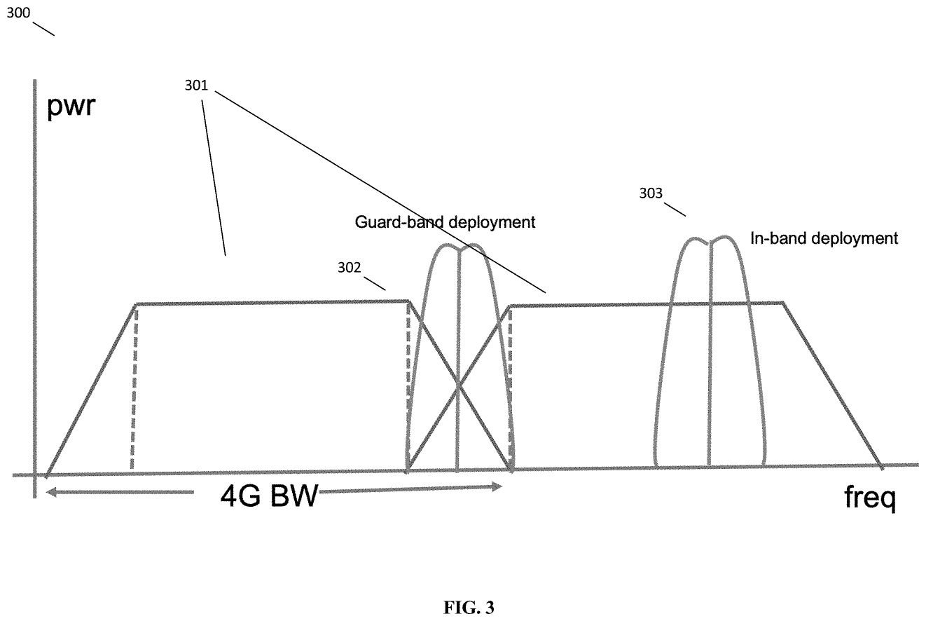

FIG. 3 is a diagram showing two options for the creation of a 2G NB/IOT carrier, in accordance with some embodiments. Diagram 300 shows two 4G carriers 301 that are in use. Two deployments, 302 and 303, are shown. Deployment 302 is a narrowband 2G IOT deployment deployed in a guard band between the two 4G carriers 301. Deployment 303 is a narrowband 2G IOT deployment deployed within an LTE carrier, with mitigations such that no 4G data is sent over that carrier in the specific portion being used for 2G. The 2G and 4G base stations are coordinated, either by communicating directly in some embodiments or through a gateway or intervening node in some embodiments.

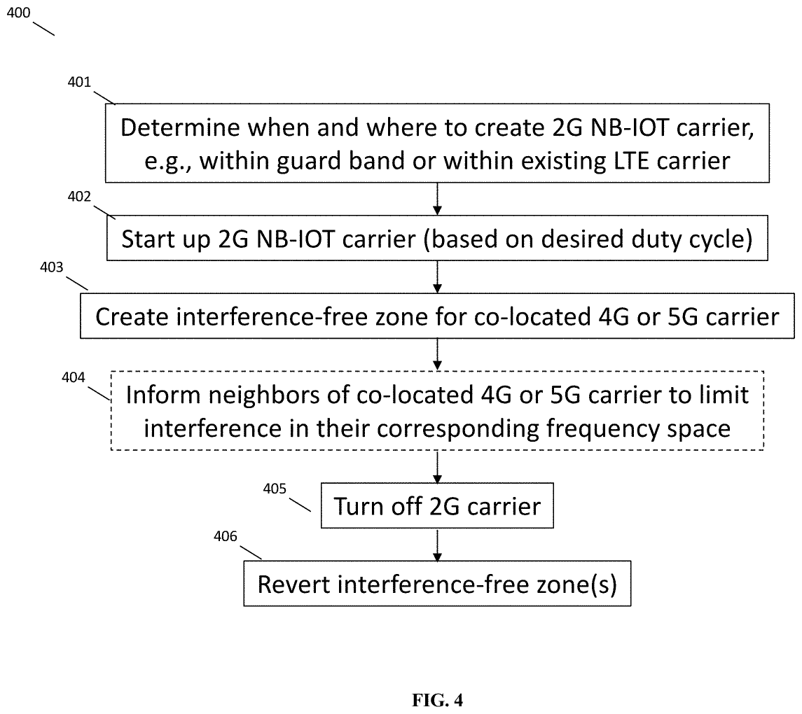

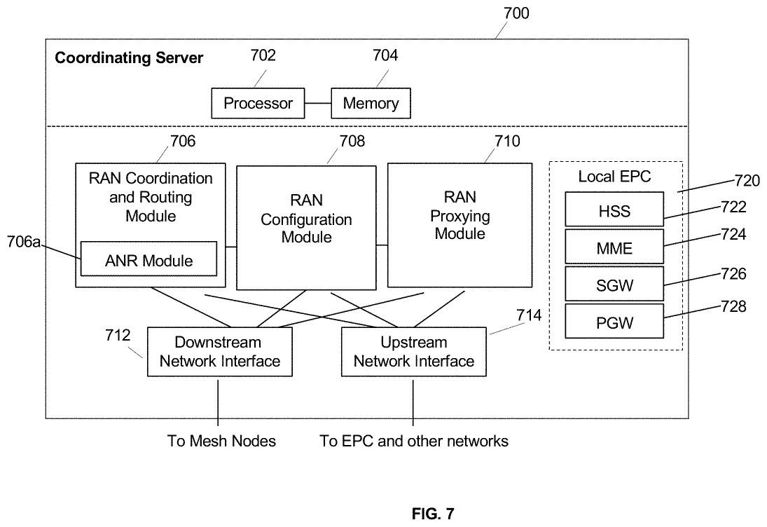

FIG. 4 is a flowchart 400 of a method for creating a 2G NB/IOT carrier, in accordance with some embodiments. The steps of flowchart 400 are understood to be able to be executed at a base station, such as a co-located 4G or 5G base station or at another proximate RAN node, or in the cloud, or at a coordinating server as shown in FIG. 7. At step 401, a determination is made regarding when and where to create 2G NB-IOT carrier, e.g., within a guard band or within existing LTE carrier. This determination is made based on one or more of the following factors, in some embodiments: the width of a regulated guard band in a particular location or according to a particular radio access standard; the 2G band needs of a specific NB-IOT use case or device; whether the existing LTE carriers (or 5G carriers) are in heavy use or have capacity; whether the existing 4G or 5G carriers can still be used with a block of spectrum reallocated from the middle; etc. At step 402, the 2G carrier is started up based on the determination of step 401 and optionally also based on a desired duty cycle, which may include one or more of: a specific known time schedule for one or more 2G devices; a known amount of data or bandwidth that is understood to be needed; or some combination thereof, in some embodiments. At step 403, the co-located base station may create, or may be instructed to create, an interference-free zone in the 2G NB-IOT carrier's band by not broadcasting on that band, using one or more of the methods described herein. At step 404, the neighbors of the co-located base station may optionally be informed and requested to perform interference mitigations similar to those at step 403. At step 405, the 2G carrier is turned off; and at step 406, the interference-free zones of step 403 are turned off.

In some embodiments, the use of 5G guard bands for 2G NB/IOT carriers is also contemplated, particularly since 5G numerologies allow for a variety of combinations of 5G bands, such that one or more flexible gaps between two 5G bands could be able to fit a 2G carrier, either permanently or for a determinate period of time.

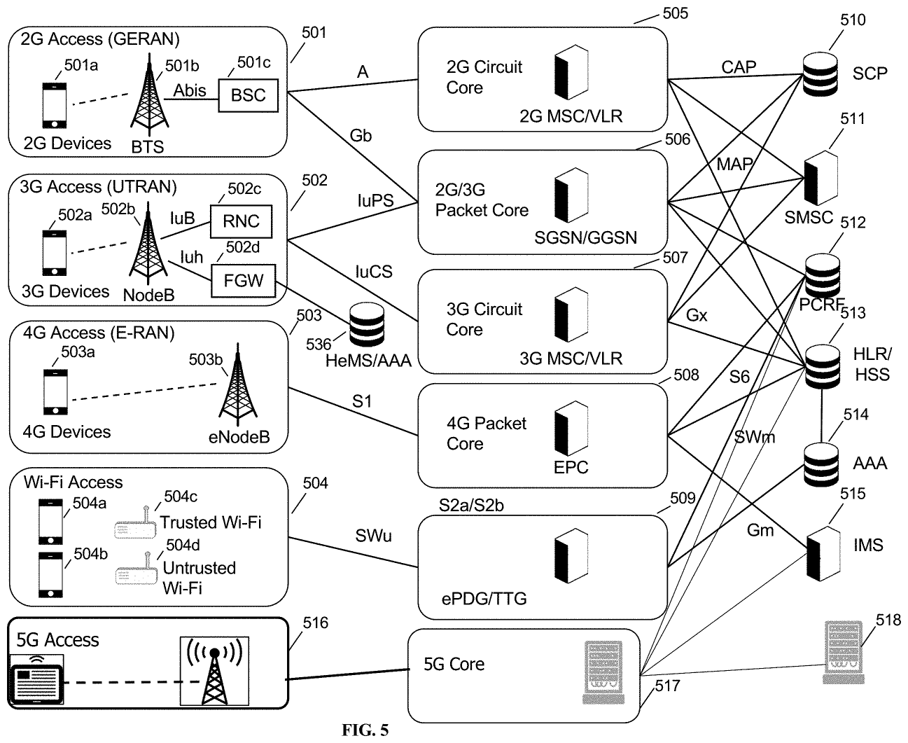

FIG. 5 is a schematic network architecture diagram for 3G and other-G prior art networks. The diagram shows a plurality of “Gs,” including 2G, 3G, 4G, 5G and Wi-Fi. 2G is represented by GERAN 501, which includes a 2G device 501a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point 504c and an untrusted Wi-Fi access point 504d. The Wi-Fi devices 504a and 504b may access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 4G circuit core 508 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. The present invention is also applicable for 5G networks since the same or equivalent functions are available in 5G. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

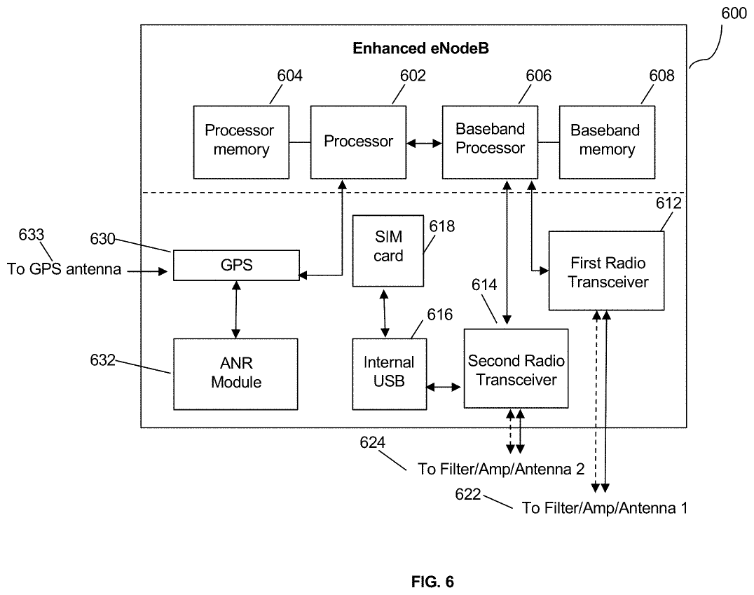

FIG. 6 shows an enhanced eNodeB for performing the methods described herein, in accordance with some embodiments. eNodeB 500 may include processor 502, processor memory 604 in communication with the processor, baseband processor 606, and baseband processor memory 608 in communication with the baseband processor. Mesh network node 600 may also include first radio transceiver 612 and second radio transceiver 614, internal universal serial bus (USB) port 616, and subscriber information module card (SIM card) 618 coupled to USB port 616. In some embodiments, the second radio transceiver 614 itself may be coupled to USB port 616, and communications from the baseband processor may be passed through USB port 616. The second radio transceiver may be used for wirelessly backhauling eNodeB 600.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 610 and 612. Baseband processor 606 may also perform operations to decode signals received by transceivers 612 and 614. Baseband processor 606 may use memory 608 to perform these tasks.

The first radio transceiver 612 may be a radio transceiver capable of providing LTE eNodeB functionality, and may be capable of higher power and multi-channel OFDMA. The second radio transceiver 614 may be a radio transceiver capable of providing LTE UE functionality. Both transceivers 612 and 614 may be capable of receiving and transmitting on one or more LTE bands. In some embodiments, either or both of transceivers 612 and 614 may be capable of providing both LTE eNodeB and LTE UE functionality. Transceiver 612 may be coupled to processor 602 via a Peripheral Component Interconnect-Express (PCI-E) bus, and/or via a daughtercard. As transceiver 614 is for providing LTE UE functionality, in effect emulating a user equipment, it may be connected via the same or different PCI-E bus, or by a USB bus, and may also be coupled to SIM card 618. First transceiver 612 may be coupled to first radio frequency (RF) chain (filter, amplifier, antenna) 622, and second transceiver 614 may be coupled to second RF chain (filter, amplifier, antenna) 624.

SIM card 618 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 602 for reconfiguration.

A GPS module 630 may also be included, and may be in communication with a GPS antenna 632 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 632 may also be present and may run on processor 602 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

FIG. 7 shows a coordinating server for providing services and performing methods as described herein, in accordance with some embodiments. Coordinating server 600 includes processor 702 and memory 704, which are configured to provide the functions described herein. Also present are radio access network coordination/routing (RAN Coordination and routing) module 706, including ANR module 706a, RAN configuration module 708, and RAN proxying module 710. The ANR module 706a may perform the ANR tracking, PCI disambiguation, ECGI requesting, and GPS coalescing and tracking as described herein, in coordination with RAN coordination module 706 (e.g., for requesting ECGIs, etc.). In some embodiments, coordinating server 700 may coordinate multiple RANs using coordination module 706. In some embodiments, coordination server may also provide proxying, routing virtualization and RAN virtualization, via modules 710 and 708. In some embodiments, a downstream network interface 712 is provided for interfacing with the RANs, which may be a radio interface (e.g., LTE), and an upstream network interface 714 is provided for interfacing with the core network, which may be either a radio interface (e.g., LTE) or a wired interface (e.g., Ethernet).

Coordinator 700 includes local evolved packet core (EPC) module 720, for authenticating users, storing and caching priority profile information, and performing other EPC-dependent functions when no backhaul link is available. Local EPC 720 may include local HSS 722, local MME 724, local SGW 726, and local PGW 728, as well as other modules. Local EPC 720 may incorporate these modules as software modules, processes, or containers. Local EPC 720 may alternatively incorporate these modules as a small number of monolithic software processes. Modules 706, 708, 710 and local EPC 720 may each run on processor 702 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders, as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MIME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces. Non-IOT applications of 2G, for example, could be used in accordance with some embodiments.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method, comprising:
determining when and where to create a 2G/Narrowband-Internet of Things (NB-IOT) carrier at a 2G base station;
starting up the 2G/NB-IOT carrier;
creating an interference-free zone for a co-located 4G or 5G carrier co-located with the 2G base station;
turning off the 2G/NB-IOT carrier; and
reverting the interference-free zone.

2. The method of claim 1, further comprising embedding one or more 2G/NB-IOT carriers in a guard band of 4G/5G.

3. The method of claim 1, further comprising transmitting a 2G/NB-IOT carrier from a co-located base station.

4. The method of claim 1, further comprising using Self-organizing Network (SON) information to determine when a 2G/NB-IOT carrier should be started or shut down.

5. The method of claim 1, further comprising shutting down a 2G/NB-IOT carrier after use.

6. The method of claim 1, further comprising creating interference free zones in required regions of the spectrum.

7. The method of claim 1, further comprising creating interference free zones using a Relative Narrowband Transmit Power (RNTP) Information Element of a X2AP protocol.

8. The method of claim 1, further comprising creating interference free zones across multiple neighboring eNBs.

9. The method of claim 1, further comprising SON may also inform an affected neighbor of a punctured eNB/gNB to limit interference in its corresponding frequency space to mitigate intercell interference to the 2G/NB-IoT carrier.

10. The method of claim 1, further comprising using a coded pattern of bits in an RNTP message to indicate either guard band use or power level of the 2G/NB-IOT carrier.

11. The method of claim 1, further comprising over-allocating Physical Uplink Control Channel (PUCCH) resources.

12. The method of claim 1, further comprising scheduling only Physical Uplink Control Channel (PUCCH) resources that are not the outermost PUCCH frequency resources of a used frequency band.

13. The method of claim 1, further comprising not scheduling Physical Uplink Shared Channel (PUSCH) in earmarked frequency resources of the 2G/NB-IOT carrier.

14. The method of claim 1, further comprising donating resources to the 2G/NB-IOT carrier to ensure that its Physical Hybrid ARQ Indicator Channel (PHICH) interference in the donated resources is minimal to none.

15. The method of claim 1, further comprising donating resources to the 2G/NB-IOT carrier and not transmitting 4G or 5G reference signals in the donated resources.

16. The method of claim 1, further comprising choosing, at an eNodeB or gNodeB, Radio Network Temporary Identifiers (RNTIs) to ensure that Physical downlink Control Channel (PDCCH) is not transmitted in the donated resources.
